(19) United States
(12) Patent Application Publication
(10) Pub. No.: US 2018/0274729 A1
(43) Pub. Date: Sep. 27, 2018

(54) OVERFILL PROTECTION MEANS

(71) Applicant: CRYOSHELTER GMBH, Dobl-Zwaring (AT)

(72) Inventor: Matthias Rebernik, Dobl-Zwaring (AT)

(21) Appl. No.: 15/781,667

(22) PCT Filed: Dec. 15, 2016
(86) PCT No.: PCT/AT2016/060129

§ 371 Date: Jun. 5, 2018

(30) Foreign Application Priority Data
Dec. 18, 2015 (AT) A 51084/2015

(51) Int. Cl. F17C 13/02; F17C 5/02

(52) U.S. Cl. CPC F17C 13/021; F17C 5/02; F17C 2205/0332; F17C 2250/0413; F17C 2250/061; F17C 2250/075; F17C 2260/022; F17C 2223/0153

(57) ABSTRACT

An overfill protection means for storing liquefied gases in a tank container, comprising a housing into which the filling line runs for filling the tank container, a closure which is arranged so as to be movable between a closing position preventing filling and an open position releasing filling, and a float, which float is coupled to a trigger mechanism. The trigger mechanism is movable by the float between an engaged position and a release position depending on the liquid level in the tank container, wherein, in the engaged position, the trigger mechanism engages the closure and keeps the closure in the open position, while being supported on the housing, and wherein, in the release position, the trigger mechanism releases the closure, whereby the closure is movable into the closing position by the flowing liquefied gas.

### BACKGROUND OF THE INVENTION

### 1. The Field of the Invention

The invention relates to an overfill protection means in a tank container according to the preamble of claim 1. Such an overfill protection means is known from the publication GB 2 329 007 A.

### 2. The Relevant Technology

Overfill protection means are required especially for safe storage of liquefied gases or other liquids in tank containers in order to limit the height of the liquid level and thereby the maximum mass within the tank during the filling of the tank container, whereby safe storage can be ensured permanently irrespective of environmental influences (temperature, solar radiation, etc.).

In this connection, overfill protection means are generally known which comprise a float which is directly connected to a closure via a connecting element. By filling the tank container, the float is moved upwards with the steadily rising liquid level, whereby the closure coupled to the float is moved into a position closing the fill opening. Upon reaching a predetermined fill level, the fill opening is completely closed by the closure, whereby further filling is prevented and the filling process is thus stopped. Such an overfill protection means is known, for example, from the patent US 2010/0288774 A1.

Furthermore, overfill protection means are known which are formed by a tubular housing and comprise a cylindrical float, wherein the diameter of the float is smaller than the diameter of the tubular housing. As a result, the overfill protection means can be mounted from the outside in any tank container with an appropriate receptacle, e.g., a flange. Such an overfill protection means is known, for example, from the patent FR 2 476 790. The tubular housing of the overfill protection means disclosed in the patent FR 2 476 790 has a fill opening which is closable by means of a closure movably mounted in the housing, which is triggered by the float depending on the liquid level prevailing in the tank container. The closure and the housing form a cavity, wherein part of the liquid flowing into the tank container is continuously branched off and guided into the cavity. The cavity has a drain through which the level accumulating in the cavity can run off. Upon reaching a certain preset liquid level, the float closes the drain of the cavity, whereby the cavity fills up steadily and, upon exceeding its maximum fill level, pushes the closure movably mounted in the housing against the tank fill opening, thus stopping the filling process. A further overfill protection means of this type is known from the U.S. Pat. No. 4,313,459. The filling protection means disclosed in the U.S. Pat. No. 4,313,459 is composed of a standard operating valve to which an overfill protection unit is attached by means of a thread. The standard operating valve thereby serves as a connection for the filling hose, wherein, by means of a hand wheel attached thereto, the filling process can be terminated also manually directly on the valve. The overfill protection unit is composed essentially of a cylinder having a blind hole, which blind hole is directly adjacent to the standard operating valve and communicates with the interior of the tank container via lower and upper openings fitted in the lateral surface of the cylinder. Upon reaching a certain preset liquid level, a sleeve is slid over a cylinder by the float, whereby a cavity is created between the sleeve and the cylinder. If the sleeve covers the lower openings, part of the liquid floods the cavity, whereby, as result of the filling pressure of the liquid, the sleeve will slide over the residual lateral surface of the cylinder, covering also the upper openings of the sleeve, without any further contribution from the float. As a result, all openings through which the liquid might flow into the tank are covered by the sleeve, and the filling process is stopped. If the standard operating valve is closed, the pressure in the cavity decreases, and a pre-loaded spring pushes the float back down.

The embodiments known from the prior art turn out to be disadvantageous in that the overfill protection means in most cases show only a gradual closing sequence, whereby, using overfill protection means of that kind, a clear signal that the overfill protection valve is closed usually cannot be obtained. In addition, the gradual closing process leads to longer filling times during the filling of a tank container, in particular for tank containers which have a large horizontal, but small vertical extension. Furthermore, such known overfill protection means are susceptible to failure, since cylindrical floats are more prone to getting stuck and jamming, respectively. As a result, the risk arises that the float will not activate reliably or not at all and that, subsequently, increased evaporation losses will occur.

### SUMMARY

The invention is based on the object of building an overfill protection means which, due to its simple structure, will last for the whole service life of a tank container and, upon reaching the maximum tank fill, will close the filling line abruptly, thus reliably preventing the tank container from being overfilled.

According to the invention, this problem is solved by an overfill protection means having the features of claim 1 and of claim 10. The dependent claims relate to further particularly advantageous embodiments of the invention.

The overfill protection means according to the invention comprises at least one actuating element, and the trigger mechanism is formed by at least one locking element, with the float acting upon the at least one locking element via the at least one actuating element. A guide is designed on the outer lateral surface of the housing. The at least one actuating element can be formed by a tube piece which is put over the housing, is guided by the guide and acts upon the at least one locking element with a changing contour of its inner lateral surface. The actuating element can also be formed by at least one lever which acts upon the at least one locking element in a gravity-loaded or spring-loaded manner, wherein the float is displaceable relative to the lever.

By means of the overfill protection means according to the invention, it is possible to abruptly and reliably stop a filling of a tank container for storing liquefied gases. Because of the rising liquid level with the filling of the tank container, a trigger mechanism is activated by the float as soon as a preset maximum filling volume of the tank container is reached. In doing so, a closure located in the filling path, towards which the liquefied gas is flowing, is released by the trigger mechanism, whereby the closure is flung abruptly into a closing position shutting off the filling path via the pressure of the flowing fluid. In this regard, the filling path defines the path taken by the fluid as it flows from the filling line through the overfill protection means into the tank container. The abrupt stopping of the filling has the advantage that a point in time at which the overfill protection means or, respectively, the trigger mechanism is activated can be detected accurately, for example, by a sensor or an appropriate signal detection means. This can be accomplished, for example, by a pressure sensor in the filling line. Furthermore, an advantage obtained by the design according to the invention of the overfill protection means is that, as result of the abrupt stopping of the filling, the full flow cross-section will be preserved until the end of the filling process, whereby there will be no unnecessary prolongation of the filling-up process.

Furthermore, by the structural design according to the invention of the overfill protection means, the advantage is obtained that, even in case of vibrations, strong accelerations or light blows, for example, due to liquid building up in a truck tank as a result of braking or acceleration processes, damage to the overfill protection means is prevented and, at a standstill of the vehicle, said means will immediately be fully operational again.

In this context, the housing has, particularly advantageously, a tubular design and is manufactured from stainless steel. By using stainless steel, the housing can be assembled easily with other parts of the tank container, as they are generally made of stainless steel in the preferred fields of application such as, for example, in the storage of liquefied gases or also in the food industry.

Preferably, the closure is designed in the form of a valve and has a counterseat surface, wherein the tubular housing has a valve seat incorporated into the housing. In this way, the advantage is obtained that, when the closure is in the closing position, the valve seat and the counterseat surface sealingly abut against each other because of a pressure prevailing in the filling line, and, thus, a particularly good sealing can be achieved. In this context, the closure is advantageously made of brass, whereby a particularly good safeguarding against leakage of the valve is achieved. Not only does brass have very good sealing properties, brass also has very good processing characteristics and particularly good sliding properties. Because of that, the closure can be mounted displaceably in a guide fitted directly in the housing without any lubrication being provided. A further advantage of constructing the housing from stainless steel and of constructing the closure from brass proves to be that brass and stainless steel are not prone to cold welding. So as to further increase the sealing effect between the housing and the closure, the possibility exists to use other materials such as, e.g., rubber rings as elements constituting sealing surfaces. For example, a valve seat ring made of rubber may be fitted into the housing.

In a particularly inexpensive embodiment variant, the trigger mechanism is formed by several engagement levers which, rotatably mounted to the housing, engage the closure by means of, in each case, one engagement knob formed on them and keep said closure in the open position releasing the filling path or, respectively, release the closure, which is triggered by the float, when the maximum filling capacity of the tank container is reached. Advantageously, the design of the engagement levers is as light-weight and stiff as possible. For this reason, the engagement levers are preferably made of aluminium.

The float is coupled to the trigger mechanism via at least one actuating element. The trigger mechanism can be formed by locking elements in the form of balls or pins, and the closure may have at least one indentation, for example, a rounded groove, into which the locking elements engage when the closure is in the closing position. In this way, a very low-friction coupling between the closure, the trigger mechanism, the actuating element and the float can be achieved. According to the invention, the at least one actuating element is formed by a tube piece or by several levers. In a further embodiment variant, the at least one actuating element is formed by several levers or rods which engage each other, whereby the float can be arranged irrespective of the position of the housing in the tank container. This indeed increases the production-related expenditure, but decreases the mechanical strain on the components, especially on the trigger mechanism, in case of vibrations or strong accelerations.

In one variant of the invention, the overfill protection means suitably comprises a compression-proof and closed float. In this embodiment, the compression-proof, closed float may be exposed also to high overpressure or, respectively, rapidly changing pressures, without the float undergoing a deformation. Advantageously, a tank filling valve according to the invention comprises a torus-shaped float. A torus-shaped float provides the advantage of little dependency on the density of the stored liquid, since said float shape has a flat structure with a large surface area in relation to its construction height. Thus, a substantially proportional displacement of the torus-shaped float depending on the fill level of the stored liquid is ensured. Depending on the intended use and the liquid, floats can be used which have one cavity or several cavities. Thus, for example, the use of sponges or porous materials is conceivable as well.

In a further alternative variant of the invention, the float in a tank filling valve is open at least in sections. For example, such a float has sections which are open downwardly or, respectively, on an underside of the float.

In a preferred embodiment variant, the float is mounted so as to be displaceable in an axial direction, whereby unintended pinning or blocking of the float can be avoided and, hence, an operation of the overfill protection means of the tank filling valve can be ensured which is as failure-free as possible. In a torus-shaped float, said float is arranged, for example, coaxially to the tubular housing and is guided along the housing via the actuating element or other appropriate elements such as, for example, different types of guides. Particularly suitably, a lower and an upper stopper are formed at the tubular housing in a tank filling valve according to the invention, whereby the displacement of the float relative to the housing is restricted. The lower stopper is advantageously designed on the tubular housing and constitutes the stopper on which the at least one actuating element and/or the float rest(s) when the trigger mechanism is in the engaged position. Advantageously, the tubular housing is arranged in the installation position with its longitudinal axis vertical in the tank container, whereby the at least one actuating element and/or the float rest(s) on the lower stopper due to gravity. If the overfill protection means and hence the tubular housing are arranged in an arbitrary position within the tank container, the trigger mechanism or, respectively, the float is advantageously kept in the engaged position at the lower stopper by means of a spring force which is lower than the buoyancy force of the float. The upper stopper is the stopper on which the at least one actuating element and/or the float abut(s) when the trigger mechanism is in the release position.

Particularly advantageously, in a tank filling valve according to the invention, the float and the trigger mechanism coupled to it or, respectively, the actuating element coupled to it adjust the liquid level in the interior of the tank container at which the locking mechanism releases the closure. In the following, the liquid level at which the maximum filling capacity of the tank is reached, is referred to as the trigger level.

### BRIEF DESCRIPTION OF THE DRAWINGS

Further advantageous embodiments of the overfill protection means according to the invention are illustrated in further detail by way of example hereinbelow with reference to the figures.

FIG. 1 shows an embodiment variant of the overfill protection means according to the invention in a vertical section, comprising an actuating element which is formed by a tube piece, wherein the closure is in an open position releasing the filling path and the trigger mechanism is in an engaged position.

FIG. 2 shows the embodiment variant of the overfill protection means according to the invention in a vertical section according to FIG. 1, wherein the closure is in a closing position shutting off the filling path and wherein the trigger mechanism is in a release position.

FIG. 3 shows a further embodiment variant of the overfill protection means according to the invention in a vertical section, wherein the actuating elements are formed by levers.

FIG. 4 shows a further embodiment variant of the overfill protection means according to the invention in a vertical section, wherein the actuating elements are formed by levers.

FIG. 5 shows a further embodiment variant of the overfill protection means according to the invention in a vertical section, comprising an actuating element which is formed by a tube piece comprising catch elements, wherein the closure is in an open position releasing the filling path and the trigger mechanism is in an engaged position.

FIG. 6 shows the embodiment variant of the overfill protection means according to the invention in a vertical section according to FIG. 5, wherein the closure is in a closing position shutting off the filling path and the trigger mechanism is in the release position.

### DETAILED DESCRIPTION

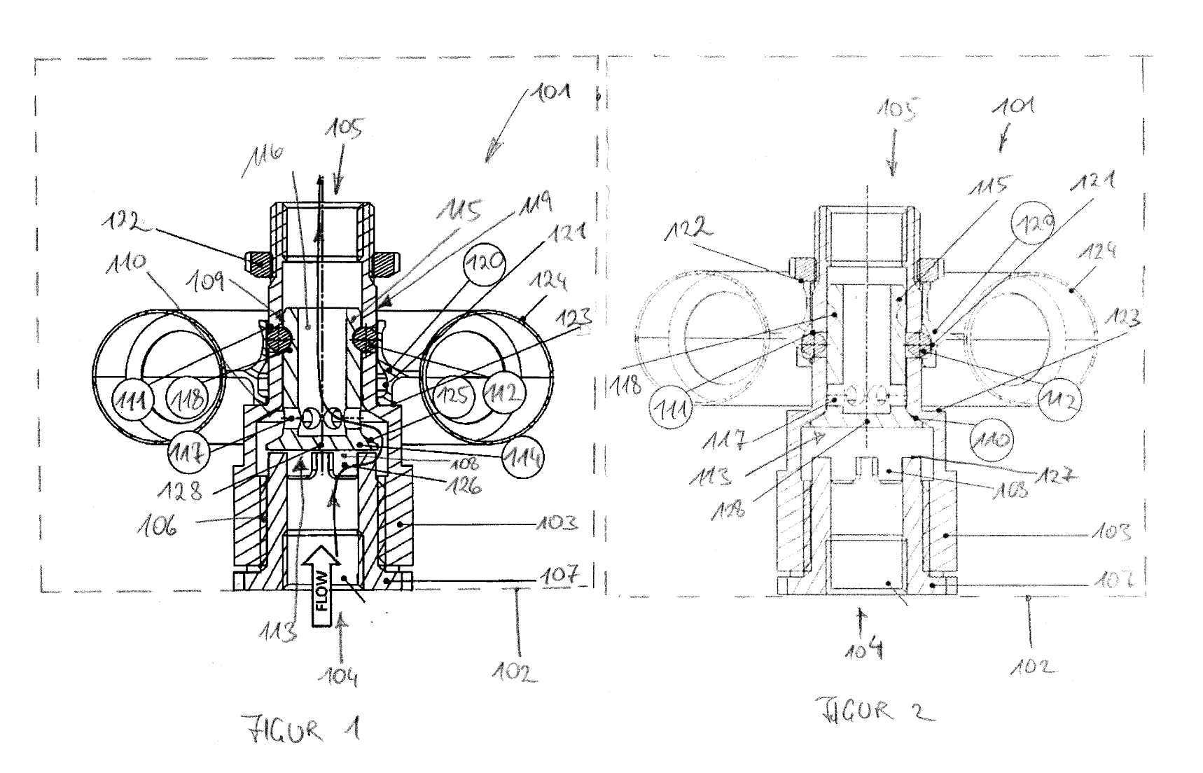

FIG. 1 and FIG. 2 show a first embodiment variant according to the invention of an overfill protection means 101 in a tank container 102, comprising a tubular housing 103, which tubular housing 103 has an inlet opening 104 at one end and an outlet opening 105 at its other end. In the inlet opening 104, a female thread 106 is formed into which a tubular spacer 107 is screwed. A filling line, which is not illustrated, can be coupled to the spacer 107 for fill-up or, respectively, for supplying, for example, a liquefied gas by means of a tank coupling, which is not illustrated. Furthermore, exemptions 108 are formed on the spacer 107. Adjacent to the outlet opening 105, a valve guide 109 is formed within the tubular housing 103, the valve guide having approximately the same diameter as the outlet opening 105. A shoulder formed by the different diameters of the valve guide 109 and the inlet opening 104 within the tubular housing 103 is configured as a valve seat 110. In the area of the valve guide 109, recesses 111 for locking elements, which, in the illustrated embodiment variant, are designed as balls 112, are provided in the tubular housing 103, preferably spaced apart equally. In this embodiment variant, the balls 112 thus form the trigger mechanism and can be displaced between an engaged position and a release position. Depending on the intended use of the overfill protection means 101, different numbers of balls 112 may be used. For example, it is useful to use more balls 112 for liquids of high density than for liquids of lower density. It may also be advantageous, depending on the intended use, to use balls 112 made of different materials. In the embodiment variant illustrated in FIG. 1 and FIG. 2, the balls 112 are preferably made of aluminium the surface of which is polished so as to ensure the best possible sliding properties. In the valve guide 109 of the tubular housing 103, a valve-shaped closure 113 is movably mounted coaxially to the longitudinal axis of the tubular housing 103. The valve-shaped closure 113 comprises a valve plate 114 and a valve stem 115, with a blind hole 116 being formed in the valve stem 115 coaxially to the longitudinal axis of the closure 113. On the lateral surface of the valve stem 115, fill openings 117 are formed which are connected to the blind hole 116. Furthermore, a rounded groove 118 is formed on the lateral surface of the valve stem 115. At the level of the valve guide 109, the outer lateral surface of the tubular housing 103 serves as a guide 119 for an actuating element which is formed by a tube piece 120 which has a varying contour 121 on its inner lateral surface. The tube piece 120 is attached to the tubular housing 103 in an axially movable manner, whereby the axial range of motion is limited by an upper stopper 122 and a lower stopper 123. A torus-shaped float 124 is coupled to the tube piece 120. Advantageously, the design of the tube piece 120 is as light-weight as possible, whereby less force is required for shifting it axially along the tubular housing 103. Consequently and because of the good machinability, the tube piece 120 is preferably made of aluminium.

In the embodiment variant illustrated in FIG. 1 and FIG. 2, the overfill protection means 101 is arranged vertically in the tank container 102. If the liquid level is below the trigger level, the tube piece 120 rests on the lower stopper 123 due to gravity, and the balls 112 are pushed by the tube piece 120 into the rounded groove 118 of the closure 113 the trigger mechanism is in the engaged position. As the trigger level, the liquid level is defined which arises when the maximum envisaged filling capacity of the tank container 103 is reached. When the filling process is started, the liquefied gas flows along a filling path 126 into the tank container 102, whereas the balls 112 located in the engaged position engage the rounded groove 118 of the closure 113 and keep the latter in an open position releasing the filling path 126 against a force generated by a filling pressure of the liquefied gas and acting upon the valve plate 114, while being supported on the tubular housing 103. The filling path 126 is formed by the flowing liquid which, during filling, flows into the tank container 102 through the tank coupling, which is not illustrated, the spacer 107, the exemptions 108 in the spacer 107, the fill openings 117 of the closure 113, the blind hole 116 of the closure 113 and the outlet opening 105. The filling path 126 is indicated by line 126 in FIG. 1. If the liquid level reaches the trigger level, the float 124 and thus the tube piece 120 are lifted. As a result, the balls 112 release the closure 113 due to the changing contour 121 of the inner lateral surface of the tube piece 120, whereby the balls 112 are pushed outwardly by the closure 113 which has been flung into a closing position shutting off the filling path 126—the trigger mechanism is in the release position. In this regard, see FIG. 2. The valve seat 110 in the tubular housing 103 and a counterseat surface 125 formed correspondingly on the closure 113 sealingly abut on each other in the closing position and thus close the filling path 126 and stop the filling process. If the liquid supply to the overfill protection means 101 is interrupted, the filling pressure decreases and the closure 113 falls due to gravity on a side surface 127 of the spacer 107 and into the open position releasing the filling path 126. When another filling attempt is made, the closure 113 is immediately flung back into the closing position due to the filling pressure, and the filling process is again stopped. Only after an appropriate removal of an amount of liquefied gas from the tank container 102 which decreases the liquid level, the float 124 lowers itself and hence the tube piece 120 so that the tube piece 120 again rests on the lower stopper 123, whereby the balls 112 are again pushed into the rounded groove 118 of the closure 113. As a result, the closure 113 is kept again in the open position releasing the filling path 126, and the filling process can be restarted.

According to a further embodiment variant, the closure 113 is moved into the open position releasing the filling path 126 due to a spring force, after the liquid supply to the overfill protection means 101 has been interrupted.

According to a further embodiment variant, the tube piece 120 rests on the lower stopper 123 by means of a spring force, at a liquid level below the trigger level.

According to a further embodiment variant, a relief bore 128 is formed in the valve plate 114, the relief bore being connected to the blind hole 116. In order to prevent leakage currents and to ensure abrupt closing, the diameter of the relief bore 128 is advantageously very small. The relief bore 128 prevents liquefied gas from being trapped between the closure 113 located in the closing position and the tank coupling, which is not illustrated, if the filling line is closed. Instead of the relief bore 128, an overpressure valve might be provided.

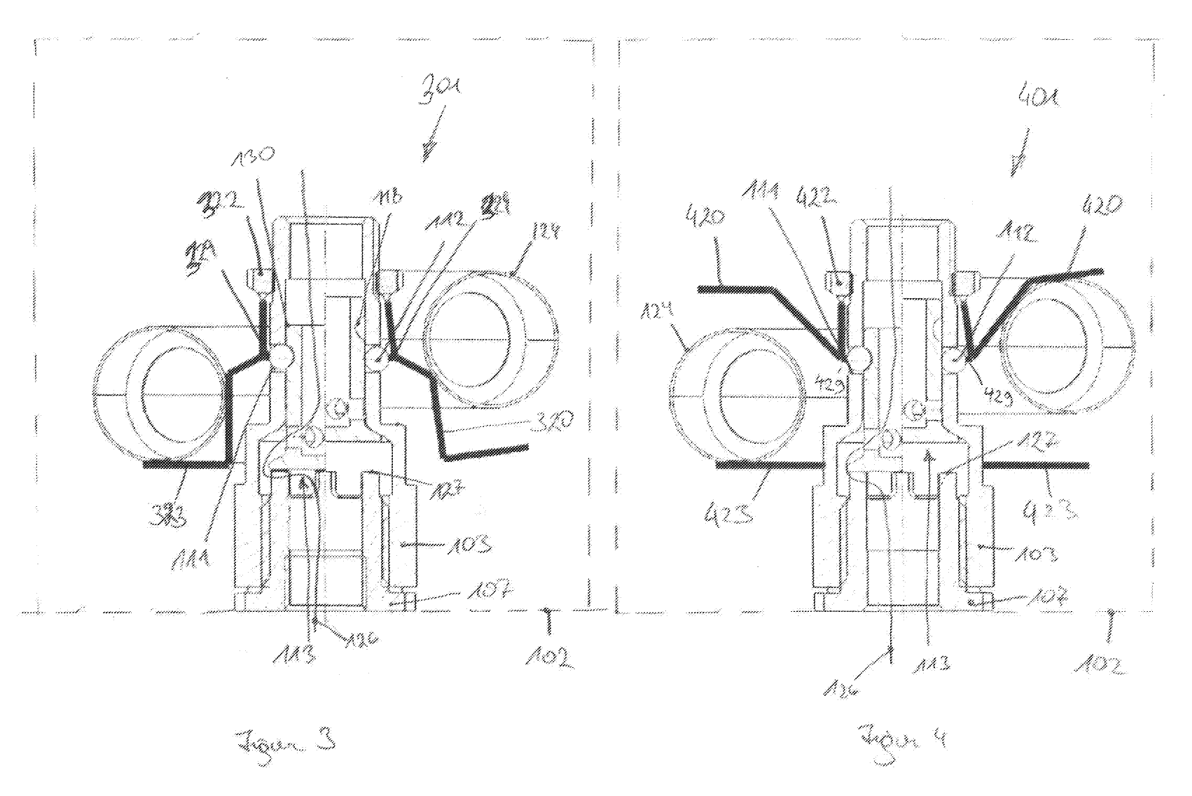

FIG. 3 shows a further embodiment variant according to the invention of an overfill protection means 301 in a tank container 102. In contrast to the embodiment variant illustrated in FIGS. 1 and 2, the at least one actuating element is formed by several levers 320 in this embodiment variant. The levers 320 are rotatably mounted to the upper stopper 322 and, via a knob 329, press down on the locking elements, which are configured as balls 112 also in this embodiment variant.

If the liquid level is below the trigger level, the torus-shaped float 124 rests on the levers 320 due to gravity, whereas the torus-shaped float 124 keeps the balls 112 in the engaged position due to the geometry of the levers 320, whereby the closure 113 is kept in the open position releasing the filling path 126. Depending on the intended use of the overfill protection means 301, different numbers of balls 112 and levers 320 may be used, wherein, as illustrated in FIG. 3, one lever 320 at a time together with its knob 329 advantageously pushes one ball 112, respectively, into the rounded groove 118 of the closure 113. In this embodiment variant, the levers 320 also form the lower stopper 323 for the float 124. If the liquid level in the tank container 102 reaches the trigger level, the float 124 is lifted by the liquid level. The float 124 thus releases the levers 320, whereby the balls 112 are no longer pushed into the rounded groove 118, and the closure 113 is released. The closure 113 is flung into the closing position, and the filling process is stopped. By elements not illustrated, the balls 112 can be prevented from falling out. If the liquid supply to the overfill protection means 301 is stopped, the filling pressure decreases and the closure 113 falls due to gravity on a side surface 127 of the spacer 107 and into the open position releasing the filling path 126. If the liquid level has fallen once more because of the removal of a sufficient amount of liquefied gas, the float 124 will again rest on the levers 320, whereby the balls 112 are pushed back into the rounded groove 118 of the closure 113 located in the open position.

According to a further embodiment variant, the closure 113 has a shorter valve stem 115, whereby the closure 113 is kept in the open position by means of the upper edge 130, while being supported on the balls 112. The balls 112 are thereby protected against falling into the tubular housing 103 by recesses 111 which converge slightly toward the inside in a conical fashion.

FIG. 4 shows a further embodiment variant according the invention of an overfill protection means 401 in a tank container 102. In contrast to the embodiment variant illustrated in FIG. 3, the balls 112 are pushed into the rounded groove 118 by the weight of the levers 420 at a liquid level below the trigger level, whereby the balls 112 are located in the engaged position and the closure 113 is kept in the open position releasing the filling path 126. Also in this variant, the levers 420 are supported on the upper stopper 422 and act upon the balls 112 by means of knobs 429 attached to the levers 420.

If the liquid level is below the trigger level, the float 124 rests on the lower stoppers 423 due to gravity. In this embodiment variant, the lower stopper 423 is configured as a ring which is firmly connected to the housing 103. The weight of the levers 420 pushes the balls 112 into the rounded groove 118 of the closure 113 according to the lever principle, thus keeping the latter in the open position releasing the filling path 126. Upon reaching the trigger level, the float 124 lifts the levers 420, whereby, in turn, the closure 113 is released by the balls 112 and flings into the closing position. By means of an upper stopper, which is not illustrated, the path of the float 124 can be given an upper limit, and/or the balls 112 can be prevented from falling out of the tubular housing 103. If the liquid supply to the overfill protection means 401 is interrupted, the filling pressure decreases and the closure 113 falls due to gravity on a side surface 127 of the spacer 107 and into the open position releasing the filling path 126. If, as a result of the removal of a sufficient amount of liquefied gas, the liquid level has fallen again to such an extent that the float 124 no longer presses against the levers 420, the weight of the levers 420 pushes the balls 112 back into the rounded groove 118 of the closure 113 located in the open position, whereby said closure is held.

According to a further embodiment variant, the lower stopper 423 is formed by several rods distributed at equal intervals around the tubular housing 103, wherein one rod at a time is connected to one lever 420, respectively. As a result, the advantage is obtained that the weight acting upon the balls 112 for keeping the closure 113 in the open position according to the lever principle is increased, since the weights of the lower stopper 423 and the float 124 are added to the weight of the levers 420. This embodiment variant is suitable especially for inflowing liquid streams of high density in large amounts.

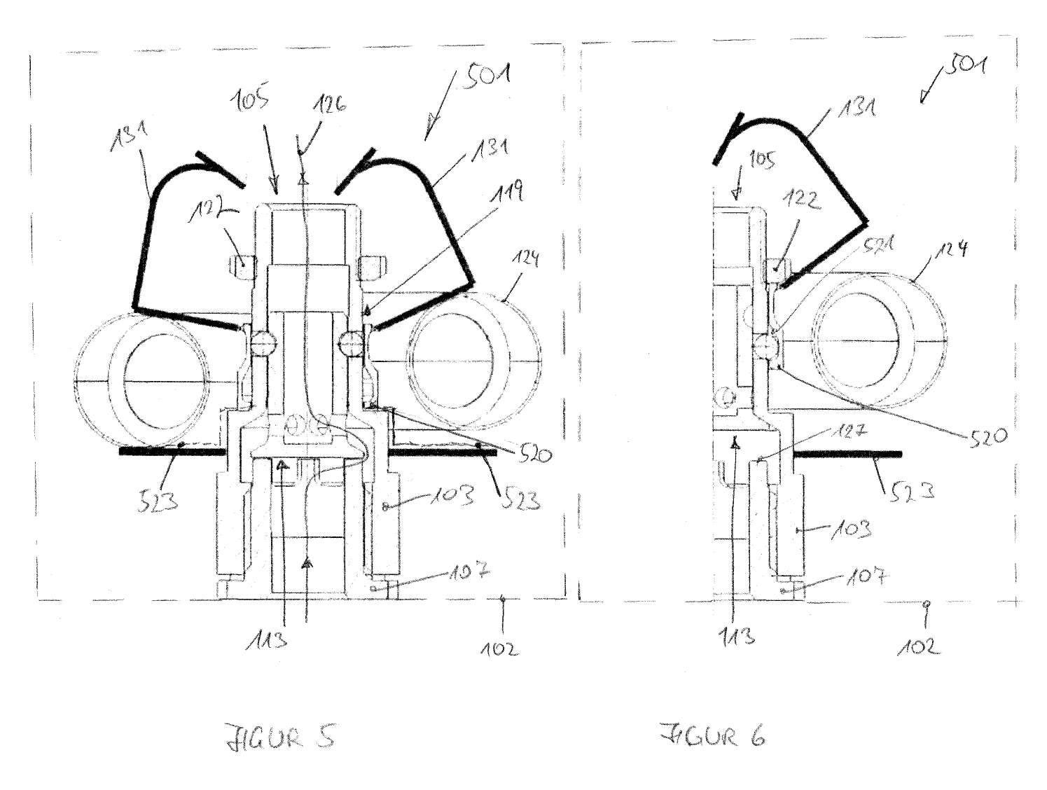

FIGS. 5 and 6 show a further embodiment variant according to the invention of an overfill protection means 501 in a tank container 102. In contrast to the embodiment variant illustrated in FIG. 1 and FIG. 2, in said embodiment variant, the actuating element formed as a tube piece 520 is not moved axially along the guide 119 by means of the float 124, but by means of catch elements 131 rotatably mounted to the tube piece 520. In this connection, the catch elements 131 are configured such that they are displaceable by the float 124 between a position in the filling path 126 and a position outside of the filling path 126. In this embodiment variant, the lower stopper 523 is formed by a ring firmly connected to the housing 103 and by a shaft shoulder on the housing 103, with the shaft shoulder serving as a lower stopper 523 for the tube piece 520 and the ring serving as a lower stopper 523 for the float.

Upon reaching the trigger level and thus the maximum capacity, the float 124 moves the catch elements 131 into the filling path (shown in the right half of the image of FIG. 5). The catch elements 131 are caught by the liquefied gas flowing into the tank container 102 and fold into the centre of the outlet opening 105, where they meet and virtually form a catching screen behind the outlet opening 105 (illustrated in FIG. 6). By means of the pressure prevailing in the flowing liquefied gas, the catching screen is moved upwards, and, therewith, the tube piece 520 coupled to the catching screen, whereby the balls 112 release the closure 113 due to the changing contour 521 of the inner lateral surface of the tube piece 520. The closure 113 is flung into the closing position by the flowing liquefied gas, and fill-up is stopped. Since the filling path 126 is interrupted, the catch elements 131 fold back as a result of gravity and rest on the float 124 floating on the liquid. If the liquid supply to the overfill protection means 501 is interrupted, the filling pressure decreases and the closure 113 falls due to gravity on a side surface 127 of the spacer 107 and into the open position releasing the filling path 126. As a result of gravity, also the tube piece 120 slides downwards, whereby the balls 112 are pushed back into the rounded groove 118. Since the catch elements 131 are still in the filling path 126 because of the high liquid level, a new filling attempt would lift the tube piece 520 once more, thus releasing the closure 113, whereby re-filling is prevented. Only if, as a result of the removal of a sufficient amount of liquefied gas, the liquid level has again fallen to such an extent that the catch elements 131 slide into a position outside of the liquid path 126 due to their own weight, the tank container 102 can be re-filled.

According to a further embodiment variant, the catch elements 131 are displaced by means of a spring force back into a position adjacent to the float 124, if the filling path 126 is interrupted, and further into a position outside of the filling path 126, if the float 124 sinks down.

According to a further embodiment variant, the tube piece 520 is displaced by means of a spring force into a position in which the tube piece 520 rests on the lower stopper 523, if the closure is in the open position releasing the filling path 126.

The embodiment variants illustrated in FIG. 1 and FIG. 2, FIG. 3, FIG. 4 and FIG. 5, and FIG. 6 can be combined with each other.

1. An overfill protection means in a tank container (102) for storing liquefied gases, comprising an essentially tubular housing which is arranged in a tank interior of the tank container or projects into the tank interior and into which a filling line runs, wherein the overfill protection means for flowing liquefied gas forms a filling path between the filling line and the tank interior, a closure which is arranged so as to be movable reciprocally between a closing position shutting off the filling path and an open position releasing the filling path, and a float floating in the tank interior with an immersion depth depending on a liquid level of the stored gas, and at least one trigger mechanism upon which the float acts, wherein the trigger mechanism is movable between an engaged position and a release position triggered by the float depending on the liquid level, wherein, in the engaged position, the trigger mechanism engages the closure and keeps the closure in the open position, while being supported on the housing, and wherein, in the release position, the trigger mechanism releases the closure, whereby the closure is movable into the closing position by the flowing liquefied gas, characterized in that the overfill protection means comprises at least one actuating element and that the trigger mechanism is formed by at least one locking element, with the float acting upon the at least one locking element via the at least one actuating element, that a guide is formed on the outer lateral surface of the housing and that the at least one actuating element is formed by a tube piece, the tube piece, which is put over the housing and guided by the guide, acting upon the at least one locking element with a changing contour of its inner lateral surface.

2. An overfill protection means according to claim 1, wherein the housing has a valve seat and the closure is designed in the form of a valve and has a counterseat surface, wherein, when the closure is in the closing position, the valve seat and the counterseat surface sealingly abut against each other because of a pressure prevailing in the filling line.

3. An overfill protection means according to claim 1, wherein that the closure has at least one fill opening, wherein, in the open position, the at least one fill opening is part of the filling path, and that the at least one fill opening is closed by moving the closure into the closing position.

4. An overfill protection means according to claim 1, wherein the closure has at least one indentation, wherein the trigger mechanism engages the indentation of the closure when the closure is in the open position.

5. An overfill protection means according to claim 1, wherein the at least one locking element is formed by balls or pins.

6. An overfill protection means according to claim 1, wherein the tube piece comprises catch elements, wherein the float displaces the catch elements formed on the tube piece between a position outside of the filling path and a position in the filling path depending on the liquid level.

7. An overfill protection means according to claim 1, wherein the housing comprises an upper stopper and a lower stopper, wherein at least one of the float or the tube piece rests on the lower stopper due to gravity or spring force when the at least one locking element is in the engaged position, and wherein at least one of the float or the tube piece abuts against the upper stopper when the at least one locking element is in the release position.

8. An overfill protection means according to claim 1, wherein the float has a torus-shaped design.

9. An overfill protection means according to claim 1, comprising a tank coupling, which tank coupling connects the filling line to the housing during filling and which tank coupling ensures fast shut-off and connection of the filling line, wherein the tank coupling sealingly shuts off the tank container from the environment outside of the tank container when the filling line is shut off, characterized in that the closure has a relief bore, wherein a cavity is formed within the housing between the tank coupling and the closure when the closure is in the closing position and the filling line is shut off and wherein said cavity communicates with the tank container via the relief bore.

10. An overfill protection means in a tank container for storing liquefied gases, comprising an essentially tubular housing which is arranged in a tank interior of the tank container or projects into the tank interior and into which a filling line runs, wherein the overfill protection means for flowing liquefied gas forms a filling path between the filling line and the tank interior, a closure which is arranged so as to be movable reciprocally between a closing position shutting off the filling path and an open position releasing the filling path, and a float floating in the tank interior with an immersion depth depending on a liquid level of the stored gas, and at least one trigger mechanism to which the float is coupled, wherein the trigger mechanism is movable between an engaged position and a release position triggered by the float depending on the liquid level, wherein, in the engaged position, the trigger mechanism engages the closure and keeps the closure in the open position, while being supported on the housing, and wherein, in the release position, the trigger mechanism releases the closure, whereby the closure is movable into the closing position by the flowing liquefied gas, characterized in that the overfill protection means comprises at least one actuating element and that the trigger mechanism is formed by at least one locking element, wherein the at least one locking element is coupled to the float via the at least one actuating element, with the at least one actuating element acting upon the at least one locking element, wherein the at least one actuating element is formed by at least one lever, wherein the at least one lever acts upon the at least one locking element in a gravity-loaded or spring-loaded manner, and wherein the float is displaceable relative to the lever.

11. An overfill protection means according to claim 10, wherein the at least one lever forms a lower stopper, with the float resting on said lower stopper due to gravity or spring force when the at least one locking element is in the engaged position.

12. An overfill protection means according to claim 10, wherein the housing has a valve seat and the closure is designed in the form of a valve and has a counterseat surface, wherein, when the closure is in the closing position, the valve seat and the counterseat surface sealingly abut against each other because of a pressure prevailing in the filling line.

13. An overfill protection means according to claim 10, wherein the closure has at least one fill opening, wherein, in the open position, the at least one fill opening is part of the filling path, and that the at least one fill opening is closed by moving the closure into the closing position.

14. An overfill protection means according to claim 10, wherein the closure has at least one indentation, wherein the trigger mechanism engages the indentation of the closure when the closure is in the open position.

15. An overfill protection means according to claim 10, wherein the at least one locking element is formed by balls or pins.

16. An overfill protection means according to claim 10, wherein the float has a torus-shaped design.

17. An overfill protection means according to claim 10, comprising a tank coupling, which tank coupling connects the filling line to the housing during filling and which tank coupling ensures fast shut-off and connection of the filling line, wherein the tank coupling sealingly shuts off the tank container from the environment outside of the tank container when the filling line is shut off, characterized in that the closure has a relief bore, wherein a cavity is formed within the housing between the tank coupling and the closure when the closure is in the closing position and the filling line is shut off and wherein said cavity communicates with the tank container via the relief bore.

18. An overfill protection means according to claim 4, wherein the at least one indentation comprises a groove.

19. An overfill protection means according to claim 14, wherein the at least one indentation comprises a groove.
